(19) United States
(12) Patent Application Publication
(10) Pub. No.: US 2026/0169442 A1
(43) Pub. Date: Jun. 18, 2026

(54) CHRONOGRAPH MECHANISM AND HOROLOGY MOVEMENT COMPRISING SUCH A CHRONOGRAPH MECHANISM

(71) Applicant: ETA SA MANUFACTURE HORLOGÈRE SUISSE, Grenchen (CH)

(72) Inventors: Stéphane Bachmann, Büren an der Aare (CH); Olivier Mertenat, Grenchen (CH)

(73) Assignee: ETA SA MANUFACTURE HORLOGÈRE SUISSE, Grenchen (CH)

(21) Appl. No.: 19/374,143

(22) Filed: Oct. 30, 2025

(30) Foreign Application Priority Data
Dec. 17, 2024 (EP) 24220724.9

(51) Int. Cl. G04F 7/08

(52) U.S. Cl. CPC G04F 7/0814

(57) ABSTRACT

A chronograph mechanism (10) for a horology movement (1) including a first counter wheel (21) secured to a first zero reset organ (51), a second counter wheel (22) secured to a second zero reset organ (52), not coplanar, the chronograph mechanism (10) including a zero reset mechanism (100) including: a first hammer (110) and a second hammer (120) configured on two levels; the first hammer (110) and the second hammer (120) pivoting separately relative to each other; a resilient coupling organ (116), arranged between the first hammer (110) and the second hammer (120), having a first bracket (116.1) bearing on a first support organ (111) on the first hammer (110) and a second bracket (116.2) bearing on a second support organ (112) on the second hammer (120) to elastically restrain the second hammer (120) against a support surface (118) on the first hammer (110).

### CROSS-REFERENCE TO RELATED APPLICATIONS

This application claims priority to European Patent Application No. 24220724.9, filed on December 17, 2024, the entire contents of which are incorporated herein by reference.

### TECHNICAL FIELD OF THE INVENTION

The present invention relates to a chronograph mechanism for a horology movement.

More specifically, the invention relates to a chronograph mechanism comprising a mechanism for zero resetting the chronograph counters.

The invention also relates to a timepiece comprising such a chronograph mechanism.

### TECHNOLOGICAL BACKGROUND

Chronograph mechanisms enable time to be measured on demand using multiple chronograph counters, for example minutes and seconds.

Chronograph mechanisms typically comprise a zero reset mechanism for resetting the chronograph counters, thereby returning them to a reference position so that time can be again measured on demand.

Conventionally, such a zero reset mechanism consists of a zero reset control that can be operated by the user, for example via a button or an actuating blom stud accessible from outside the middle in which the horology movement is mounted.

The zero reset control engages, directly or indirectly, via levers with one or more zero reset hammers that strike the zero reset cams carried by the various chronograph counters.

The chronograph counters and corresponding hands are reset to zero when the hammers bear on the reset cams, generating a sufficient drive couple to change the position of the chronograph counters until they return to a reference position determined by the geometry of the hammers and of the reset cam.

In the existing chronograph mechanisms, the hammers are either made in one piece or consist of separate parts, and are secured to each other by securing means. In this case, they have a common actuating control. An exemplary embodiment is described in particular in application EP 2241945.

Setting zero reset mechanisms is complicated, time-consuming and requires skilled workmanship. Indeed, to set such a mechanism, the seconds hammer has to be brought into contact with the seconds zero reset cam in its reference position. Then, the pane on the minute hammer has to be filed down so that the minute zero reset cam is also in the reference position. This operation is long and intricate and can only be carried out by a specialised horologist.

One solution to this tedious setting operation is to use two overlapping hammers that are conjugate in their angular movement while allowing limited relative angular movement of one hammer with respect to the other during the zero reset. Such a solution is described in particular in patent CH 220536. In particular, this approach allows both hammers to act simultaneously on their respective heart pieces and helps keep the chronograph hands from lagging in the reference position.

However, with such a solution, the overlapping hammers come into contact with the zero reset cams with little energy because a large part of the actuating energy is absorbed by the return and damper spring, which exerts increasingly resistant stress against the movements of the hammers. There is thus a risk that the chronograph counters will not be correctly set to zero with such a mechanism.

There is thus a need for improved chronograph mechanisms and in particular for zero reset mechanisms for counters on such chronograph mechanisms.

### SUMMARY OF THE INVENTION

To this end, the invention aims to provide a chronograph mechanism that offers a solution to at least one of the aforementioned problems.

One of the objectives of the invention is to provide a zero reset mechanism that provides precise zero resetting of the various chronograph counters.

One of the objectives of the invention is to provide a reliable and secure zero reset mechanism.

One of the objectives of the invention is to provide a solution that makes it easier to assemble a set of several rotationally coupled overlapping hammers.

To this end, the invention relates to a chronograph mechanism for a horology movement comprising a first chronograph counter wheel secured to a first zero reset organ, a second chronograph counter wheel secured to a second zero reset organ, not coplanar with the first zero reset organ, the chronograph mechanism comprising a zero reset mechanism comprising:

-a first hammer and a second hammer configured on two levels to respectively engage with the first zero reset organ and the second zero reset organ; the first hammer and the second hammer pivoting separately relative to each other;

-a resilient coupling organ, arranged between the first hammer and the second hammer, comprising a first bracket bearing on

the first hammer and a second bracket bearing on the second hammer to elastically restrain the second hammer against the first hammer, so that the first hammer is rotationally coupled with the second hammer in the absence of a stress applied to the second hammer greater than a value predetermined by the stiffness of the resilient coupling organ.

Such a zero reset mechanism ensures that the chronograph counters are fully zero reset to their reference position.

With this type of architecture, rotational coupling between the two hammers is guaranteed regardless of the angular position of the hammers and of the zero reset control, since the coupling force between the two hammers is not dependent on the angular travel of the zero reset control.

In addition to the characteristics mentioned in the previous paragraph, the chronograph mechanism according to the invention can have one or more complementary characteristics from among the following, taken individually or in any technically possible combination:

a rotationally mobile eccentric organ, carried by one of the hammers, configured to engage with one of the brackets on the resilient coupling organ by changing its angular position;

the eccentric organ is carried by the first hammer, said eccentric organ having a first angular position configured to engage with the second bracket on the resilient coupling organ and to elastically restrain the resilient coupling organ so as to release the pressure on the second bracket on the second hammer;

the eccentric organ has a second angular position in which the eccentric organ is at a distance from the resilient coupling organ, such that the second bracket bears on a support organ on the second hammer;

-the first angular position of the eccentric organ is an assembly position and the second angular position of the eccentric organ is an operating position;

the eccentric organ is carried by the second hammer, said eccentric organ having a first angular position configured to engage with the second bracket on the resilient coupling organ and to elastically restrain the resilient coupling organ so that the second bracket bears on the eccentric organ;

-the eccentric organ has a second angular position in which the eccentric organ is at a distance from the resilient coupling organ, such that the second bracket bears on a support organ carried by the first hammer;

the first angular position of the eccentric organ is an operating position and the second angular position of the eccentric organ is an assembly position;

-one of the two hammers comprises a stop organ engaging against a support surface on the other hammer when no stress greater than a value predetermined by the stiffness of the resilient coupling organ is applied to the second, upper hammer;

the chronograph mechanism comprises a device for limiting relative angular movements between the first hammer and the second hammer;

the device for limiting relative angular movements consists of a prong secured to the second hammer engaging with an opening formed in the body of the first hammer;

the prong forms said second support organ on the second hammer;

the zero reset mechanism comprises a zero reset control that can be actuated by the user and is configured to rotate the one of the two hammers;

the zero reset mechanism comprises a zero reset control that can be actuated by the user and is configured to rotate the first hammer;

the first hammer comprises a first pane configured to strike the first zero reset organ, and in that the second hammer comprises a second pane configured to strike the second zero reset organ, the second pane having an angular gain relative to the first pane;

the first hammer and the second hammer have a common axis of rotation;

the chronograph mechanism comprises at least one position indicator arranged on one of the two hammers to indicate a particular angular position of the eccentric organ.

Another aspect of the invention relates to a horology movement comprising such a chronograph mechanism according to the invention.

Another aspect of the invention relates to a timepiece comprising such a horology movement according to the invention comprising a chronograph mechanism according to the invention.

The timepiece is preferentially a wristwatch comprising a watchcase configured to receive and embed the horology movement according to the invention.

### BRIEF DESCRIPTION OF THE FIGURES

The purposes, advantages and characteristics of the present invention will become apparent from the detailed description below in reference to the following figures:

FIG. 1 is a partial schematic view of an exemplary embodiment of a chronograph mechanism according to the invention in position in a horology movement;

FIG. 2 illustrates a perspective view of the chronograph mechanism illustrated in FIG. 1;

FIG. 3 is an exploded view illustrating more specifically a first hammer and a second hammer overlapping and elastically coupled by a resilient coupling organ on the chronograph mechanism according to the invention illustrated in FIG. 1;

FIG. 4 illustrates more specifically the lower hammer on the chronograph mechanism comprising a pre-assembly organ.

In all of the figures, common elements have the same reference numbers unless otherwise specified.

### DETAILED DESCRIPTION OF THE INVENTION

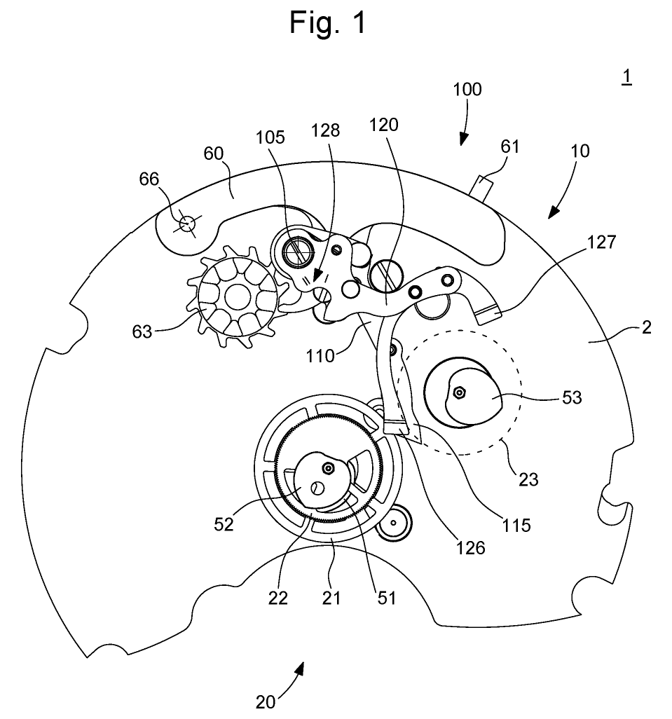

FIG. 1 is a partial schematic top view of a chronograph mechanism 10 embedded in a horology movement 1 according to the invention.

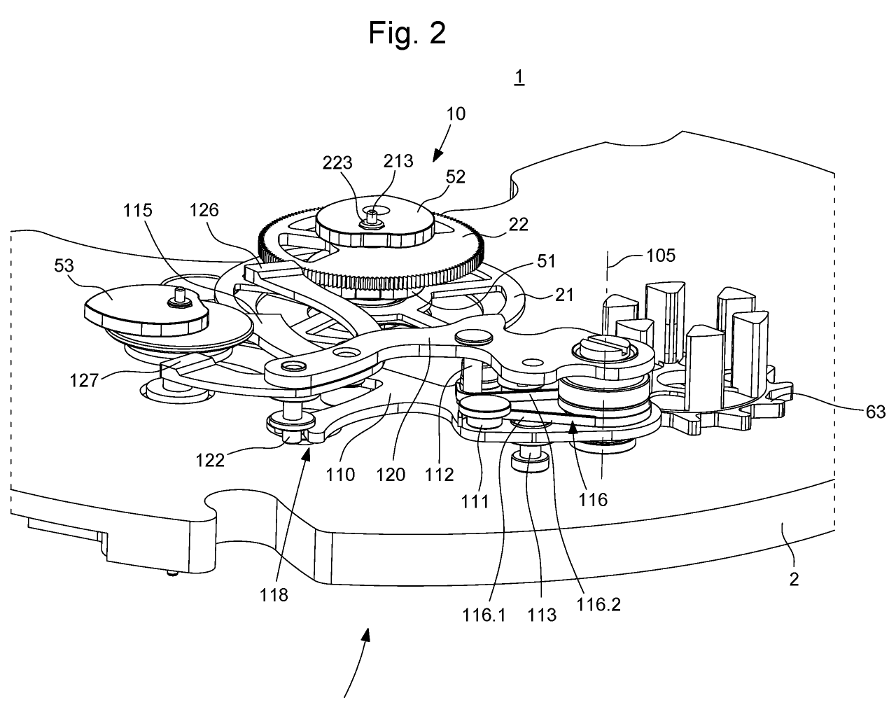

FIG. 2 illustrates a perspective view of the chronograph mechanism 10 illustrated in FIG. 1.

Referring to FIGS. 1 and 2, the horology movement 1 comprises a plate 2 acting as a support for the various elements of the horology movement 1, in particular a time train (not shown) for time graduation, that is driven by an energy source (not shown).

The chronograph mechanism 10 comprises a chronograph train 20 that can be kinematically joined, on demand, to the hour train via a coupling (not shown) controlled by a chronograph start/stop control.

For example, the coupling is a lever coupling that enables a coupling wheel to pivot. Other variant embodiments of a coupling known to those skilled in the art could also apply.

In particular, the chronograph train 20 comprises a first chronograph counter comprising a first chronograph counter wheel 21, for example a seconds counter wheel, and a second chronograph counter comprising a second chronograph counter wheel 22, for example a minute counter wheel.

The first seconds counter wheel 21 is coupled to a first arbor 213, called the seconds counter arbor, driving a seconds hand on a chronograph (not shown). The first arbor 213 also carries a first zero reset organ 51 that is rotationally secured to the arbor 213.

The second minute counter wheel 22 is coupled to a second arbor 223, called the minute counter arbor, which drives a chronograph minute hand (not shown). The second arbor 223 also carries a second zero reset organ 52 that is rotationally secured to the arbor 223.

The first arbor 213 and the second arbor 223 are coaxial.

The first wheel on the seconds counter 21 and the second wheel on the minutes counter 22 overlap and are arranged in two separate planes, overlapping and parallel. The respective zero reset organs 51, 52 also overlap each other.

The zero reset organs 51, 52 are, for example, snail-shaped, heart-shaped or other zero reset cams, where the shape enables them to be returned to a reference position of the hands when actuated by zero reset hammers.

In the example shown, the zero reset organs 51, 52 are zero reset heart pieces.

As shown, the chronograph train 20 can also comprise a third additional counter, for example an hour counter, comprising a third chronograph counter wheel 23 connected to a third zero reset organ 53.

The chronograph train 20 can comprise intermediate chronograph mobiles to obtain the desired ratios between the various counter wheels 21, 22, 23 on the chronograph mechanism 10.

The chronograph mechanism 10 also comprises a zero reset mechanism 100 for resetting the various chronograph counters and returning the zero reset organs 51, 52, 53 and the hands corresponding to these counters to their reference positions.

The zero reset mechanism 100 comprises a first hammer 110 and a second hammer 120 overlapping each other and shaped to engage respectively with the first zero reset organ 51 on the first chronograph counter and the second zero reset organ 52 on the second chronograph counter. The hammers 110, 120 are rotated by a zero reset control 60 that can be operated by the user, for example via a button or an actuating blom stud 61.

The zero reset control 60 is rotationally mobile around an axis of rotation 66 and engages directly or indirectly with one of the hammers 110, 120.

In the exemplary embodiment shown, the zero reset control 60 engages directly with the first hammer 110 located in the lower position (that is, the hammer near the plate 2). However, the zero reset control 60 can also engage directly with the second hammer 120, located in the upper position (that is, the distal hammer on the plate 2).

To this end, the first hammer 110 comprises an activation portion 113, for example a pin or a prong, securely mounted so as to protrude onto the body of the first hammer 110 and configured to engage in direct contact with a portion of the zero reset control 60.

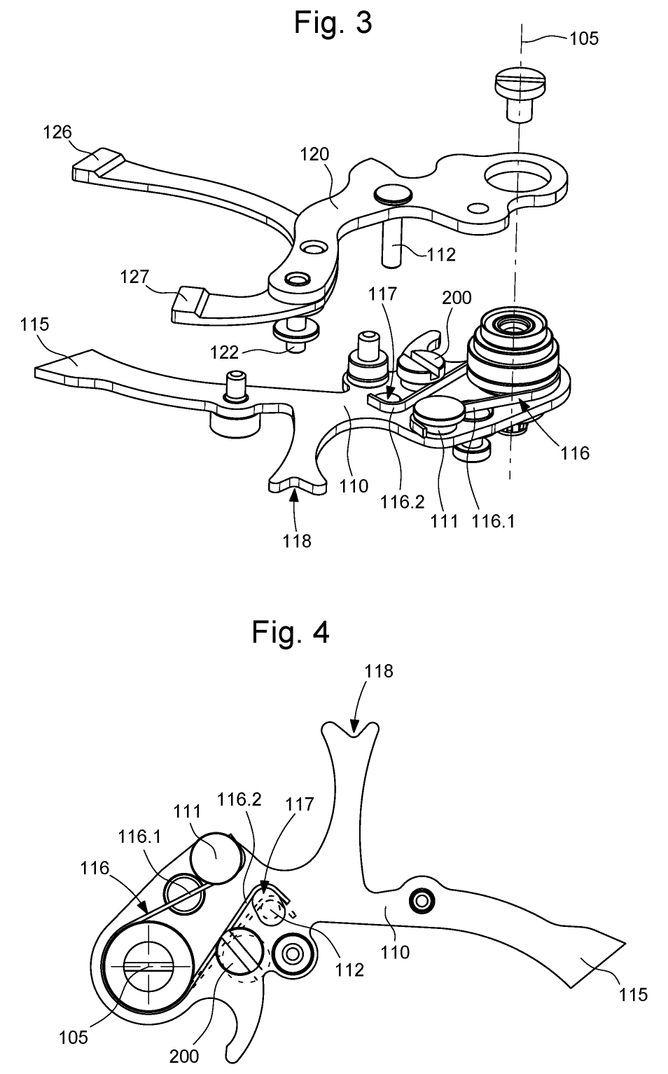

FIG. 3 more specifically illustrates an exploded view of the set of overlapping hammers 110, 120 according to the invention.

The first hammer 110 and the second hammer 120 are assembled so as to pivot separately around a common axis of rotation 105 relative to each other. According to a variant embodiment, the first hammer 110 and the second hammer 120 can have different axes of rotation that are parallel to each other.

The second hammer 120 has limited angular freedom relative to the first hammer 110. To this end, a device for limiting angular movements is arranged between the first hammer 110 and the second hammer 120 to limit the angular travel of the second hammer 120 relative to the first hammer 110.

For example, the device for limiting relative angular movements is formed by a prong 112 secured to one of the two hammers 110, 120, for example secured to the second hammer 120, engaging with an opening 117 formed in the body of the other hammer 120, 110, for example the first hammer 110, to limit the relative angular movements between the two hammers 110, 120.

The opening 117, which can be seen in FIG. 4 and which shows the first hammer 110 in greater detail, is, for example, oblong or in the shape of a circular arc, so as to allow limited relative angular movements between the two hammers 110, 120 around the axis of rotation 105.

A resilient coupling organ 116 is arranged between the first hammer 110 and the second hammer 120 to create an elastic coupling between the two hammers 110, 120.

More specifically, the resilient coupling organ 116 enables the first hammer 110 and the second hammer 120 to be rotationally coupled while allowing relative angular freedom of the previously-described second hammer 120, by elastic distortion of the resilient coupling organ 116, when a stress greater than a predetermined value, defined by the stiffness of the resilient coupling organ 116, is applied to the second hammer 120.

More specifically, the resilient coupling organ 116 comprises a first resilient bracket 116.1 bearing on a first support organ 111 on the first hammer 110, and a second resilient bracket 116.2 bearing on a second support organ on the second hammer 120.

The two resilient brackets 116.1, 116.2 are joined on an elbow-shaped central body 116.3. The resilient coupling organ 116 is, for example, a spring, a blade spring, a string spring, etc.

In the exemplary embodiment shown, the second support organ on the second hammer is formed by the prong 112 on the second hammer 120. However, a second support organ separate from the prong 112 can be provided.

The second support organ and/or the prong 112 can be added elements or elements made from the same material as the body of the second hammer 120.

The resilient coupling organ 116 is configured to restrain the second hammer 120 against the first hammer 110 when no stress greater than a value predetermined by the stiffness of the resilient coupling organ 116 is applied to the second hammer 120, so that the second hammer 120 is rotationally coupled to the first hammer 110.

More specifically, the second hammer 120 comprises a stop organ 122, directed towards the first hammer 110 and configured to engage with a support surface 118 on the first hammer 110. Under the elastic restraint of the resilient coupling organ 116 bearing on the two hammers 110, 120, the stop organ 122 on the second hammer 120 is kept pressed against the support surface 118 on the first hammer 110.

The first hammer 110 comprises a first pane 115 configured to strike the first zero reset organ 51 on the first counter. The second hammer 120 comprises a second pane 126 configured to strike the second zero reset organ 52 on the second counter.

When in a stable position, meaning when not exerting any stress on the second hammer 120 greater than a predetermined value in relation to the stiffness of the resilient coupling organ 116, the second pane 126 on the second hammer 120 is not aligned with the first pane 115 on the first hammer 110. In fact, the second pane 126 on the second hammer 120 is slightly offset towards the front (that is, in the direction of the zero reset organs 51, 52) relative to the first pane 115 on the first hammer 110.

The forward offset of the second pane 126 on the second hammer 120 ensures that both zero reset organs 51, 52 are returned to their reference position at the end of the movement of the hammers 110, 120 and of the zero reset control 60. Indeed, when the hammers 110, 120 are actuated, once the second zero reset organ 52 on the second counter is in the zero reset position, a supplementary angular displacement of the hammers 110, 120 will generate a stress on the second pane 126 on the second hammer 120 that is greater than the stiffness of the resilient coupling organ 116, which will allow the first zero reset organ 51 on the first counter to complete its zero reset if it has not yet reached its reference position. A retrograde movement of the second hammer 120 relative to the first hammer 110 is thus initiated by counteracting the elastic stress of the resilient coupling organ 116.

The chronograph mechanism described below functions as follows:

When the user presses the zero reset control 60 via the actuating blom stud 61, the zero reset control 60 pivots around its axis of rotation 66, which engages the activation portion 113 on the first hammer 110 and pivots the first hammer 110 around the axis of rotation 105.

If no stress is applied to the second pane 126 on the second hammer 120, the second hammer 120 is rotationally coupled to the first hammer 110 and is thus also set in motion by the zero reset control 60 and pivots around the axis of rotation 105.

The two hammers 110, 120 continue their angular movement under the action of the zero reset control 60 until the panes 115, 126 strike the respective zero reset organs 51, 52.

Due to the advance of the second pane 126 on the second hammer 120, the second zero reset organ 52 will be reset to the reference position before reaching the full angular travel of the zero reset control 60.

As the zero reset control 60 continues its angular displacement, the second zero reset organ 52 on the second counter, being in the reference position which is a stable position, exerts a stress on the second pane 126 that is greater than the stiffness of the resilient coupling organ 116 and that elastically distorts the resilient coupling organ 116 and changes the relative position of the two hammers 110, 120. This decoupling of the two hammers 110, 120 allows the first hammer 110 to continue its angular movement, driven by the zero reset control 60, to ensure that the first zero reset organ 51 on the first counter is completely reset.

When the zero reset control 60 reaches the end of its travel, the two panes 116 and 126 are aligned relative to each other and the two zero reset organs 51, 52 are positioned in their reference position.

The second hammer 120 further comprises a third pane 127 configured to reset the third zero reset organ 53 to its reference position.

According to the invention, the zero reset mechanism 100 advantageously comprises an eccentric organ 200 that makes it easier to assemble the resilient coupling organ 116 between the two hammers 110, 120. Such a pre-assembly organ 200 also enables the two hammers 110, 120 to be pre-assembled before they are assembled in the horology movement 1.

According to a first variant embodiment shown in the figures, the eccentric organ 200 enables, in particular, the supporting contact between the resilient coupling organ 116 and one of the hammers 110, 120 to be released, particularly when assembling the two hammers 110, 120.

For example, the eccentric organ 200 is configured to release the supporting contact between the resilient coupling organ 116 and the prong 112 on the second hammer 120, or to release the supporting contact between the resilient coupling organ 116 and a second support surface supporting part of the resilient coupling organ 116.

To this end, as shown in FIG. 4, the eccentric organ, for example an eccentric clamping organ, an eccentric screw, is carried, for example, by the first hammer 110 and is rotationally mobile around its axis of rotation. The eccentric organ has a body with an axis of rotation that is not centred on the body.

Friction is provided, for example between the eccentric organ 200 and the first hammer 110 to ensure that the eccentric organ is kept in position.

The eccentric organ 200 has a first position, referred to as the assembly position, configured to engage with the second bracket 116.2 on the resilient coupling organ 116 and to elastically restrain the resilient coupling organ 116 so as to be recessed relative to the prong 112. Thus, the eccentric organ 200 enables a pre-assembly that releases the support from the second bracket 116.2 on the second hammer 120, and more specifically on the prong 112 in the exemplary embodiment described. This position is shown particularly clearly in FIG. 4.

The eccentric organ 200 also comprises a second position, referred to as the operating position, shown as a dotted line in FIG. 4, in which the eccentric organ 200 is at a distance from the resilient coupling organ 116, such that the second bracket 116.2 on the resilient coupling organ 116 is free to come into contact with the second hammer 120, and more specifically with the prong 112 in the exemplary embodiment described. This position of the resilient coupling organ 116 is also shown as a dotted line in FIG. 4.

According to a second variant embodiment, the eccentric organ 200 is used to create the elastic coupling between the two hammers 110, 120, meaning that one of the brackets on the resilient coupling organ bears on the eccentric organ when in operation.

For example, the eccentric organ 200 is carried by the second hammer 120, the eccentric organ having a first angular position configured to engage with the second bracket 116.2 on the resilient coupling organ 116 and to elastically restrain the resilient coupling organ 116 so that the second bracket 116.2 bears on the eccentric organ 200. The eccentric organ 200 has a second angular position in which the eccentric organ 200 is at a distance from the resilient coupling organ 116, such that the second bracket 116.2 bears on a support organ carried by the first hammer 110. Thus, in this variant embodiment, the second position of the eccentric organ 200 in which it is not in contact with the resilient coupling organ 116 is an assembly position. This means that during assembly, the resilient coupling organ 116 is kept pre-assembled on one of the hammers between two support members. When in use, and to couple the two hammers, the eccentric organ 200 is positioned in the first position, which is an operating position, so as to restrain the resilient coupling organ 116 and restore the support of the second resilient bracket 116.2.

The eccentric organ 200 has an impression enabling a tool to be inserted to facilitate its rotation.

Preferentially, the mechanism comprises at least one position indicator 128 arranged on one of the two hammers 110, 120 to indicate the first angular position of the eccentric organ 200 or the second angular position of the eccentric organ 200. Preferentially, the mechanism comprises a first indicator indicating the assembly position and a second indicator indicating the operating position.

Conventionally, the zero reset control 60 engages with a resilient zero reset element (not shown) configured to return the zero reset control 60 to a neutral locked position between each user actuation.

The zero reset mechanism 100 can also comprise a retaining organ (not shown) to secure the zero reset mechanism 100 and ensure that the zero reset control 60 is fully actuated. The retaining organ is configured to momentarily retain the actuation of the zero reset control 60 and thus of the hammers 11, 120, as long as a certain stress is not applied to the zero reset control 60. Such a retaining organ is a safety organ preventing an unintended zero reset of the hands of the chronograph mechanism 10. The retaining member exhibits dynamic behaviour similar to a mechanical fuse.

As shown in the various figures, the chronograph mechanism 10 comprises a column wheel 63 for controlling the various movements of various levers that bear on a column or are between two columns. Since the operation of a chronograph mechanism 10 with such a column wheel 63 is widely known, it is not necessary to further explain the operation of such a wheel.

Of course, the chronograph mechanism 10 can also be a cam-mounted chronograph mechanism replacing the column wheel 63 without departing from the scope of the invention.

The invention also relates to a timepiece, for example a wristwatch, comprising such a horology movement.

1. A chronograph mechanism for a horology movement comprising a first chronograph counter wheel secured to a first zero reset organ, a second chronograph counter wheel secured to a second zero reset organ, not coplanar with the first zero reset organ, the chronograph mechanism comprising a zero reset mechanism comprising:
a first hammer and a second hammer configured on two levels to respectively engage with the first zero reset organ and the second zero reset organ; the first hammer and the second hammer pivoting separately relative to each other;
a resilient coupling organ, arranged between the first hammer and the second hammer, comprising a first bracket bearing on the first hammer and a second bracket bearing on the second hammer to elastically restrain the second hammer against the first hammer, so that the first hammer is rotationally coupled with the second hammer when no stress greater than a value predetermined by the stiffness of the resilient coupling organ is applied to the second hammer.

2. The chronograph mechanism for a horology movement according to claim 1, wherein the zero reset mechanism comprises a rotationally mobile eccentric organ carried by one of the hammers, configured to engage with one of the brackets on the resilient coupling organ by changing its angular position.

3. The chronograph mechanism for a horology movement according to claim 2, wherein the eccentric organ is carried by the first hammer, said eccentric organ having a first angular position configured to engage with the second bracket on the resilient coupling organ and to elastically restrain the resilient coupling organ so as to release the pressure on the second bracket on the second hammer.

4. The chronograph mechanism for a horology movement according to claim 3, wherein the eccentric organ has a second angular position in which the eccentric organ is at a distance from the resilient coupling organ, such that the second bracket bears on a support organ on the second hammer.

5. The chronograph mechanism for a horology movement according to claim 4, wherein the first angular position of the eccentric organ is an assembly position and in that the second angular position of the eccentric organ is an operating position.

6. The chronograph mechanism for a horology movement according to claim 1, wherein the eccentric organ is carried by the second hammer, said eccentric organ having a first angular position configured to engage with the second bracket on the resilient coupling organ and to elastically restrain the resilient coupling organ so that the second bracket bears on the eccentric organ.

7. The chronograph mechanism for a horology movement according to claim 6, wherein the eccentric organ has a second angular position in which the eccentric organ is at a distance from the resilient coupling organ, such that the second bracket bears on a support organ carried by the first hammer.

8. The chronograph mechanism for a horology movement according to claim 7, wherein the first angular position of the eccentric organ is an operating position and in that the second angular position of the eccentric organ is an assembly position.

9. The chronograph mechanism for a horology movement according to claim 1, wherein one of the two hammers comprises a stop organ engaging against a support surface on the other hammer when no stress greater than a value predetermined by the stiffness of the resilient coupling organ is applied to the second hammer.

10. The chronograph mechanism for a horology movement according to claim 1, wherein the chronograph mechanism comprises a device for limiting relative angular movements between the first hammer and the second hammer.

11. The chronograph mechanism for a horology movement according to claim 10, wherein the device for limiting relative angular movements is formed by a prong secured to the second hammer engaging with an opening formed in the body of the first hammer.

12. The chronograph mechanism for a horology movement according to claim 11, wherein the prong forms said second support organ on the second hammer.

13. The chronograph mechanism for a horology movement according to claim 1, wherein the zero reset mechanism comprises a zero reset control that can be actuated by the user and configured to rotate one of the two hammers.

14. The chronograph mechanism for a horology movement according to claim 13, wherein the zero reset mechanism comprises a zero reset control that can be actuated by the user and configured to rotate the first hammer.

15. The chronograph mechanism for a horology movement according to claim 1, wherein the first hammer comprises a first pane configured to strike the first zero reset organ and in that the second hammer comprises a second pane configured to strike the second zero reset organ, the second pane having an angular gain relative to the first pane.

16. The chronograph mechanism for horology movements according to claim 1, wherein the first hammer and the second hammer have a common axis of rotation.

17. The chronograph mechanism for horology movements according to claim 1, wherein the chronograph mechanism comprises at least one position indicator arranged on one of the two hammers for indicating a particular angular position of the eccentric organ.

18. A horology movement comprising a chronograph mechanism according to claim 1.

19. A timepiece comprising a horology movement according to claim 18.
